(19) United States
(12) Patent Application Publication
(10) Pub. No.: US 2016/0174707 A1
(43) Pub. Date: Jun. 23, 2016

(54) CABINET DRAWER POSITION HOLDING MECHANISM

(71) Applicants: Dong Mei ZENG, Portsmith (AU); Wing Hong CHAN, Kowloon (HK)

(72) Inventors: Wing Hong CHAN, Kowloon (HK); Gary Raymond PLANT, Portsmith (HK)

(21) Appl. No.: 14/970,678

(22) Filed: Dec. 16, 2015

(30) Foreign Application Priority Data
Dec. 18, 2014 (AU) 2014277785

(51) Int. Cl. A47B 88/16; E05C 17/02

(52) U.S. Cl. CPC A47B 88/16; E05C 17/02

(57) ABSTRACT

Apparatus for holding a slidable body at a selected position intermediate fully retracted and fully extended positions with respect to a housing for the body, includes a first latch element mounted to the housing adjacent the path traversed by the slidable body, and a second latch element on the slidable body. One of the latch elements is mounted for movement into and out of engagement with the other latch element to hold the slidable body at an intermediate position defined by the other latch element. The one latch element is biased either into or out of engagement, and is movable against the bias from outside the housing.

### FIELD OF THE INVENTION

The present invention relates to apparatus for holding a slidable body at a selected intermediate position. A particularly useful application of the invention is as a position holding mechanism for a cabinet drawer that has a sliding drawer body. Although the present invention will be described with particular reference to a single cabinet drawer, it will be appreciated that the invention can be extended to multiple drawers that are fitted to a common outer cabinet housing, or to other slidable bodies such as an articles carrying sliding board that moves between its two end stops along guided rails.

### BACKGROUND ART

Commonly, cabinet drawers are installed on level and stationary ground in homes, offices, workshops etc. The drawer body of such a cabinet drawer, which moves in and out of the drawer cabinet, can stop and remain at any position within its designed range of travel due to the sliding friction on the drawer. However, when this type of cabinet drawer is installed on a floor that is not always stationary, such as the floor of a motor vehicle, ship etc., or on an inclined floor, the friction that keeps the drawer stationary at a level, steady location will be insufficient to hold the drawer motionless at positions between its ends of travel. Even where the cabinet drawer is installed on stationary and level ground, in a situation when a heavy or difficult to handle object is to be put in or taken out of the drawer, it is desirable and safer that the drawer body be positively kept stationary. Naturally, if the cabinet were installed on a moving floor, it would not be safe to use the drawer in such a situation when the drawer body tends to move.

There exist a number of patents concerned with drawer stops. U.S. Pat. No. 5,243,736 discloses a frictional stop on the drawer to prevent the unintentional removal of the drawer assembly. U.S. Pat. No. 5,435,640 shows a drawer catch to latch the drawer closed. U.S. Pat. No. 5,772,294 discloses a drawer lockout mechanism for a multi-drawer cabinet, which aims to bind the slide mechanisms of the closed drawers against sliding movement for preventing a closed drawer from being opened when any of the other drawers is open. All of these patents focus on keeping the drawer in a closed position rather than keeping the drawer stationary at positions other than its end stops.

U.S. Pat. No. 5,795,044 describes a safety latch that prevents unwanted opening of a cabinet drawer and, more particularly, a safety latch that allows partial opening of the drawer but must be manually disengaged before the drawer may be completely opened. The latching action of the device is one-way, that is, stopping the drawer only when it moves outwards from the drawer cabinet. This device allows the drawer to travel freely backwards into the drawer cabinet.

U.S. Pat. No. 5,014,875, U.S. Pat. No. 5,346,297, and U.S. Pat. No. 6,065,819 relate to the position of drawer opening through electronic position sensing devices and electro-mechanical locking devices. The drawer bodies of these inventions are partitioned into a number of compartments, and the positioning devices aim to locate one of the compartments of the drawer to facilitate the retrieval of substances that are stored in that compartment.

Reference to any prior art in the specification is not, and should not be taken as, an acknowledgment or any form of suggestion that this prior art forms part of the common general knowledge in Australia or any other jurisdiction or that this prior art could reasonably be expected to be ascertained, understood and regarded as relevant by a person skilled in the art. An object of the invention, is to provide for more reliably holding a slidable member such as a drawer stationary relative to its housing at one or more designated intermediate positions between its fully opened and fully closed positions, when the housing is installed on a moving vehicle or vessel, or when the housing is rested on an inclined floor.

### SUMMARY OF INVENTION

The invention provides apparatus for holding a slidable body at a selected position intermediate fully retracted and fully extended positions with respect to a housing for the body. The apparatus includes a first latch element mounted to the housing adjacent the path traversed by the slidable body, and a second latch element on the slidable body. One of the latch elements is mounted for movement into and out of engagement with the other latch element to hold the slidable body at an intermediate position defined by the other latch element. Said one latch element is biased either into or out of said engagement, and is movable against the bias from outside the housing.

In an embodiment of the invention, there is provided a cabinet drawer fitted with one or two solid latching elements on the drawer body, each of which moves in a set path. The set path, anchored on the drawer body, is approximately perpendicular to the travel direction of the drawer. The path can be achieved by either the provision of a sliding guide or housing for the latching element, or by mechanical linkages that constrain the path of movement. By moving the solid latching element along the set path, it can be engaged into latching recess of a stationary solid block fixed on an internal wall of the drawer cabinet, thereby keep the drawer stationary relative to its cabinet housing. By moving the solid latching element away from the latching recess on the stationary solid block, the drawer will be free to move.

In an alternative arrangement, the solid block with the latching recess is the moving element installed on the drawer body, and can be operated to engage a stationary latching element mounted on the stationary drawer cabinet.

The holding device, preferably actuated manually through mechanical or electro-mechanical coupling linkage, is advantageously strong enough to resist the inertia force that is created on the drawer body and the articles it carries when the cabinet housing is installed on a moving vehicle or vessel, or the gravitational force acting on the drawer body when it is not installed on a level floor.

It will be appreciated the co-operative engagement of the latch elements provides a positive, detent style latch against movement of the drawer in either direction.

Preferably, said one latch element is movable against the bias by hand from outside the housing. For example, the latch element may protrude from the slidable member at an outer end thereof, for example through a slot in a front panel of the slidable member. Alternatively, the one latch element may be operably linked to a locking handle for the slidable member.

In an embodiment, said one latch element is pivotable into and out of said engagement. In another embodiment, said one latch element is elongate and is rotatable about its longitudinal axis into and out of said engagement.

The first and second latch elements may comprise a projection and a seat for the projection that serves as a positive detent against sliding movement of the slidable body.

There may be plural said other latch elements that define respective spaced intermediate positions of the slidable body.

In one or more embodiments, the slidable member is a drawer in a cabinet drawer.

As used herein, except where the context requires otherwise, the term “comprise” and variations of the term, such as “comprising”, “comprises” and “comprised”, are not intended to exclude further additives, components, integers or steps.

### BRIEF DESCRIPTION OF THE DRAWINGS

Further optional and preferred features of the present invention are more fully described in the following description of several non-limiting embodiments thereof. The description is included solely for the purposes of exemplifying the present invention. It should not be understood as a restriction on the broad summary, disclosure or description of the invention as set out above. The description will be made with reference to the accompanying drawings in which:

FIG. 1 is a perspective view of a first basic form of drawer position holding mechanism, set at position unlocking mode.

FIG. 2 is a perspective view of the drawer position holding mechanism of FIG. 1, set at position locking mode.

FIG. 3 is a perspective view of a drawer in accordance with a first preferred embodiment of the present invention, fitted with the first basic form of drawer position holding mechanism depicted in FIG. 1 and FIG. 2.

FIG. 4 is a perspective view of a second basic form of drawer position holding mechanism, set at position unlocking mode.

FIG. 5 is a perspective view of the drawer position holding mechanism of FIG. 4, set at position locking mode.

FIG. 6 is a perspective view of a drawer in accordance with a second preferred embodiment of the present invention, fitted with the second basic form of drawer position holding mechanism depicted in FIG. 4 and FIG. 5.

FIG. 7 is a perspective view of an improved form of drawer position holding mechanism, set at position unlocking mode.

FIG. 8 is a perspective view of the improved form of drawer position holding mechanism of FIG. 7, set at position locking mode.

FIG. 9 is a perspective view of another improved form of drawer position holding mechanism, set at position unlocking mode.

FIG. 10 is a perspective view of the improved form of drawer position holding mechanism of FIG. 9, set at position locking mode.

In the drawings, like structures are referred to by like numerals throughout the several views. The drawings shown are not necessarily to scale, with emphasis instead generally being placed upon illustrating the principles of the present invention.

### DESCRIPTION OF EMBODIMENTS

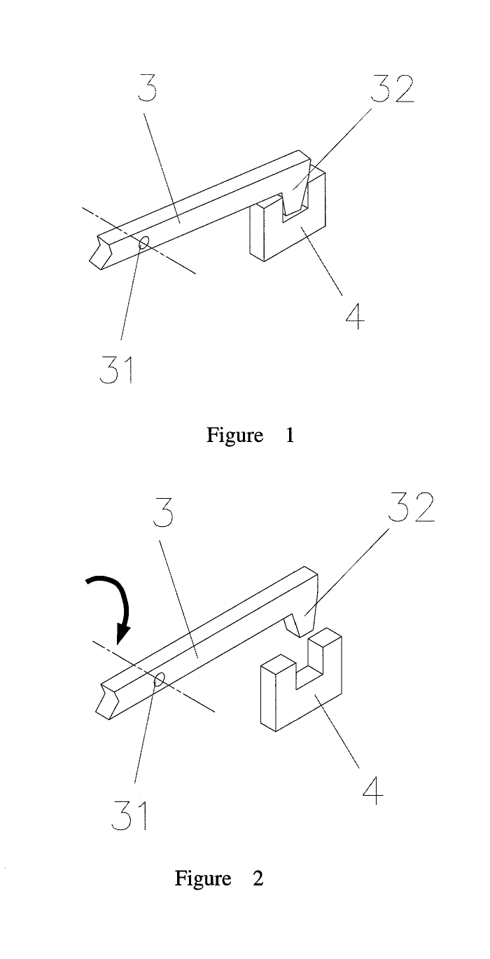

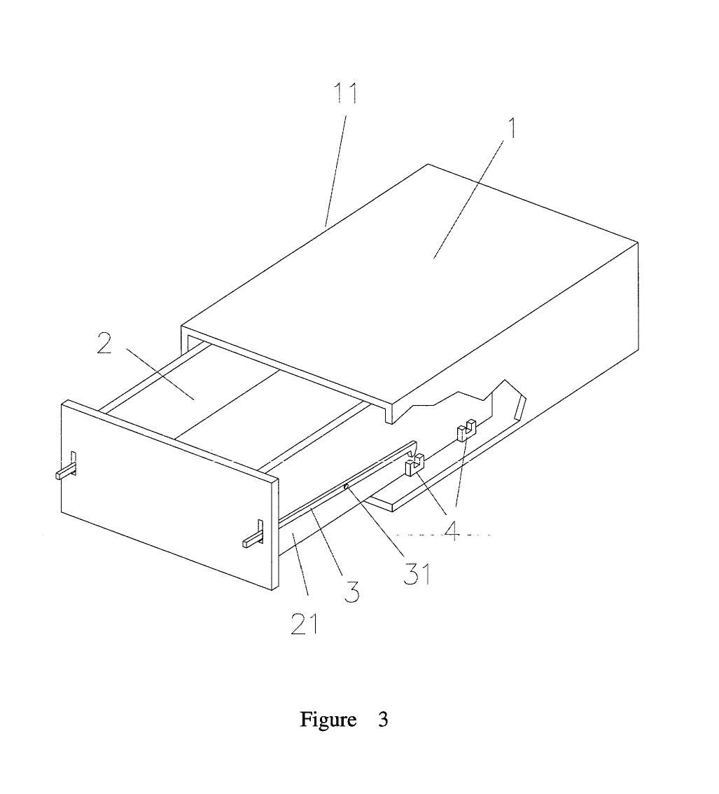

With reference to a first preferred embodiment of the present invention as shown in FIG. 1 to FIG. 3, the cabinet drawer 11 of the preferred embodiment comprises an outer cabinet housing 1, a sliding drawer body 2 that is adapted to slide in and out of the cabinet housing 1, drawer position locking bars 3 mounted on the respective sides 21 of the drawer body, and stationary locking blocks 4 mounted on an internal wall, in this case the bottom wall or floor, of the drawer cabinet. Only one set of locking blocks 4 is visible in FIG. 3. Drawer slide sets are not shown in the figures as they do not related to the present invention, or they may not be needed for some types of drawers.

As shown in FIG. 3, a pivot pin 31 pivotable mounts the position locking bar 3 of this preferred embodiment on the respective side of the sliding drawer body. The inner or distal end of the locking bar 3 is configured as a solid latching element, in this case a depending tapered projection 32 as shown in FIG. 1 and FIG. 2. When the drawer slides to a pre-determined position, and as the locking bar 3 swings in an appropriate direction about the pivot pin 31, this latching element 32 engages into an U-shaped recess of the respective stationary latching blocks 4, as shown in FIG. 1. When the locking bar 3 swings in the reverse direction about the pivot pin 31, the latching element 32 moves away from the U-shaped recess of the stationary latching blocks 4, as shown in FIG. 2.

The locking bar 3 can be biased to, and thereby retained in, one or two of its swinging end positions by either spring force, frictional force, or a detention mechanism. In the simplest form, the outer or proximate ends of locking bars 3 protrude through respective slots 3a in the front panel of the sliding drawer, as shown in FIG. 3 and are thereby movable against the bias by hand from outside the housing, and from in front of the drawer. Alternatively, and in most practical cases, the locking bars 3 are linked to other mechanisms, such as, but not limited to, a drawer locking handle, through which the actuating movement of the bars 3 can be effected.

FIG. 3 shows one of the preferred embodiments of the placement of the drawer position holding mechanism. Other forms of embodiment, such as having a single set position holding mechanism instead of two sets as shown in FIG. 3, and the placement of the position locking mechanism on the underside wall of the sliding drawer, are within the scope of this invention.

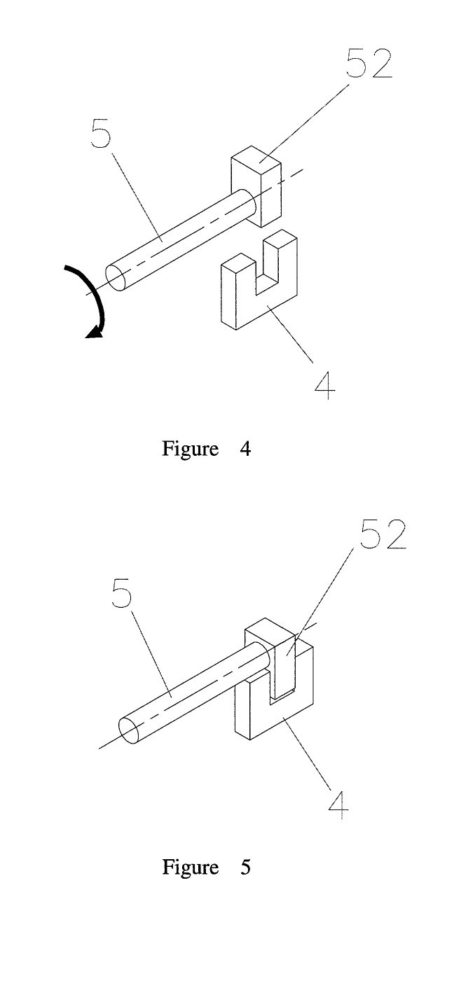

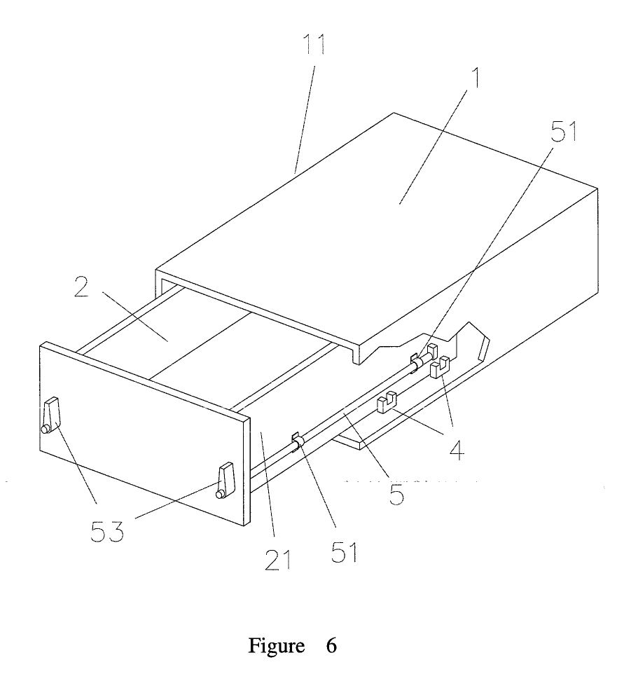

With reference to a another preferred embodiment of the present invention as shown in FIG. 4 to FIG. 6, the cabinet drawer 11 of the preferred embodiment comprises an outer cabinet housing 1, a sliding drawer body 2 that is adapted to slide in and out of the cabinet housing 1, drawer position locking bars 5 held on the respective sides 21 of the drawer body by brackets 51, and drawer position locking blocks 4 mounted are the internal wall, in this case the bottom wall or floor, of the drawer cabinet. Only one set of locking blocks 4 is visible in FIG. 6. Drawer slide sets are also not shown in the figures as they do not related to the present invention, or they may not be needed for some types of drawers.

As shown in FIG. 6, the position holding bar 5 of this preferred embodiment is held by brackets 51 on the side of the sliding drawer body in such a way that bar 5 can turn about but is restrained from moving along its longitudinal axis. At the inner or distal end of the locking bar 5, a solid latching element 52 of rectilinear form is fixed rigidly on the bar 5. When the locking bar 5 turns about its longitudinal axis in an appropriate direction, this latching element 52 can engage an U-shaped recess of a respective stationary holding block 4, as shown in FIG. 4. When the locking bar 5 turns in another appropriate direction, the lever latching element 52 is withdrawn from the U-shaped recess of the stationary holding block 4 that it previously engaged, as shown in FIG. 5. The locking bar 5 can be detained by bias in either of its two turning end positions, which enables the latching element 52 to be engaged into or disengaged from the U-shaped recess of the holding block 4, by either spring torque, frictional force, or a detention mechanism. In the simplest form, as shown in FIG. 6, the rotation of the locking bar 5 can be actuated by a turning knob or lever 53 fitted at the outer or proximal end of bar 5, which knob or lever protrudes outside the front panel of the sliding drawer. Alternatively, and in most practical cases, the locking bars 5 are linked to other mechanisms, such as, but not limited to, a drawer locking handle, through which the actuating and turning movement of the bars 5 can be effected.

FIGS. 4, 5, and 6 shows one of the preferred embodiments of the drawer position holding mechanism. Other forms of embodiment, such as having a single set position holding mechanism instead of two sets as shown in FIG. 6, and the placement of the position locking mechanism on the underside wall of the sliding drawer, are within the scope of this invention.

A solid latching element 32 or 52 engaging the U-shaped recess on a holding block 4 achieves the position holding methods illustrated in FIG. 1 to FIG. 6. In practice, the latching element and the holding block set can be made in other shapes, such as circular pin, tapered round pin, wedge-shaped piece etc., provided that they satisfy the function of maintaining the mating pair stationary at the engaged position, and set the mating pair to be free to move relative to each other at the disengaged position.

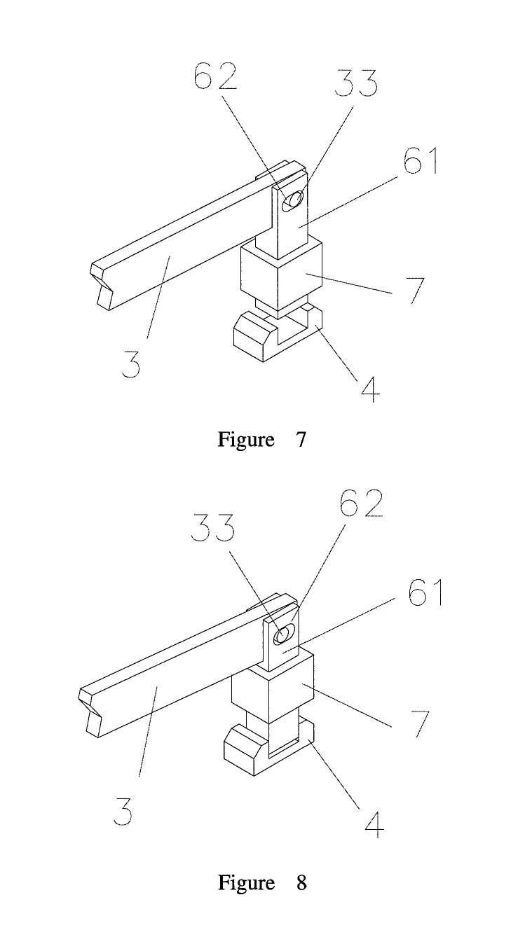

FIG. 1 to FIG. 6 illustrate the simplest forms of embodiment of the invention, showing the principles of the drawer position holding mechanism. In practice, the precision and the rigidity of the holding mechanism are required to be improved. FIGS. 7, 8, 9 and 10 illustrate alternative or improved embodiments of the position holding mechanism. Improvement of the precision and rigidity of the mechanism is achieved by designing the solid latching piece in the form of a sliding bar 61 in FIG. 7 to FIG. 10.

The sliding bar 61 slides in a housing 7, which is attached rigidly to the drawer body 2 in FIG. 3 and FIG. 6. Under the actuation of mechanism, the sliding bar 61 can move along the designed sliding direction, which is usually perpendicular to the direction of the movement of the drawer body 2 in FIG. 3 and FIG. 6. The movement of the sliding bar 61 enables the sliding bar to act as a latching element, which can be engaged or disengaged into an U-shaped recess of the holding block 4. As the holding block is fixed rigidly on an inner wall of the drawer cabinet 1, as shown in FIG. 3 and FIG. 6, engagement or disengagement of the sliding bar 61 with the holding block 4 holds or releases the movement of the drawer body 2 respectively.

FIG. 7 and FIG. 8 show a way of actuating the sliding bar 61. A bar 3, pivoted on the side wall of the drawer body, is actuated to turn about its pivot such that the ends swing up and down along a circular path. A solid pin 33, in FIG. 7 and FIG. 8, is attached to one of the ends of the bar 3. The end portion of this pin 33 fits inside oblong holes 62 that are made on the sliding bar 61. When bar 3 turns about its pivot, the pin 33 pushes or pulls the sliding bar 61 in an upwards or downwards direction, resulting in engagement or disengagement of the sliding bar 61 with the holding block 4.

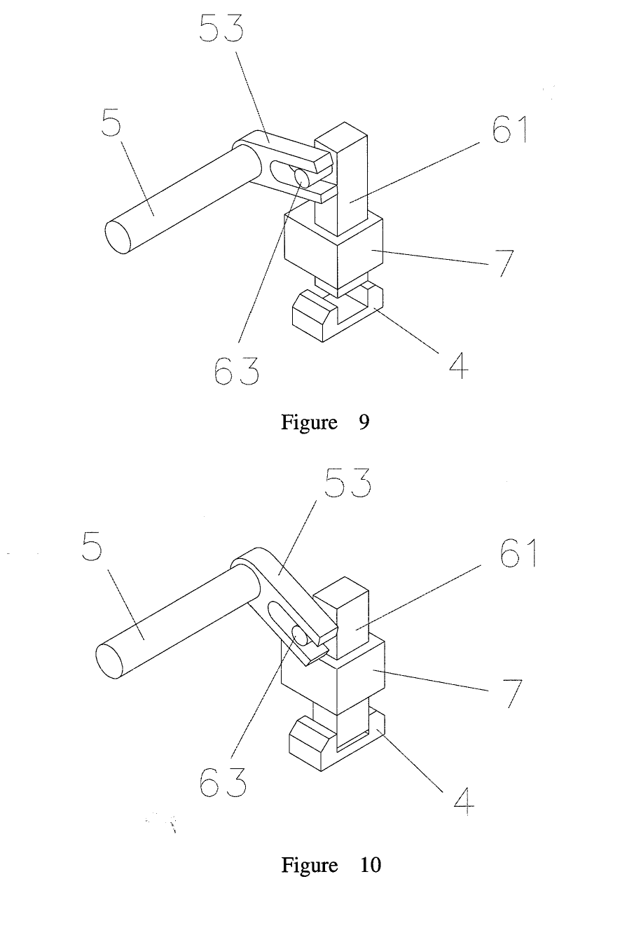

FIG. 9 and FIG. 10 show another way of actuating the sliding bar 61. A rod 5, supported on brackets mounted on the sidewall of the drawer body, can turn about its longitudinal axis, but is restrained from linear movement along its axis. A solid piece 53 with a fork-shaped cavity is attached rigidly onto one of the ends of this rod 5. The wall of this fork-shaped cavity fits over a pin 63 that is fixed on the sliding bar 61. With the turning movement of the bar 5, the sliding bar 61 is pushed or pulled through the pin 63 into or out off the U-shaped recess of the holding block 4, resulting in the holding or releasing the moving of the drawer body of the cabinet drawer.

The actuating mechanisms illustrate in FIGS. 7, 8, 9 and 10 are only examples of the embodiment of the mechanism. In practice, there are a number of ways of realizing the actuating motion for the drawer position holding mechanism. Examples of them include bar linkage, rotating or linear cam, gear train, gear rack and pinion set, push rod, wire and cable link, and electro-mechanical actuators.

1. Apparatus for holding a slidable body at a selected position intermediate fully retracted and fully extended positions with respect to a housing for the body, comprising:
a first latch element mounted to the housing adjacent the path traversed by the slidable body; and
a second latch element on the slidable body;
wherein one of the latch elements is mounted for movement into and out of engagement with the other latch element to hold the slidable body at an intermediate position defined by the other latch element;
and wherein said one latch element is biased either into or out of said engagement, and is movable against the bias from outside the housing.

2. Apparatus according to claim 1 wherein said one latch element is movable against said bias by hand from outside the housing.

3. Apparatus according to claim 1 wherein said one latch element is pivotable into and out of said engagement.

4. Apparatus according to claim 1 wherein said one latch element is elongate and is rotatable about its longitudinal axis into and out of said engagement.

5. Apparatus according to claim 1, wherein the first and second latch elements comprise a projection and a seat for the projection that serves as a positive detent against sliding movement of the slidable body.

6. Apparatus according to claim 1 wherein there are plural said other latch elements that define respective spaced intermediate positions of the slidable body.

7. Apparatus according to claim 1 wherein the one, i.e. moveable, latch element is said second latch element on the slidable body.

8. Apparatus according to claim 7 wherein the other latch element is fixed to the housing.

9. Apparatus according to claim 7 wherein said one latch element is moveable against the bias by hand by protruding from the slidable member at an outer end thereof.

10. Apparatus according to claim 9 wherein the one latch element protrudes from the slidable member through a slot in a front panel of the slidable member.

11. Apparatus according to claim 1 wherein said one latch element is moveable against the bias by hand, being operably linked to a locking handle for the slidable member.

12. Apparatus according to claim 1 wherein the slidable member is a drawer in a cabinet drawer.

13. Apparatus according to claim 5 wherein said one latch element is pivotable into and out of said engagement.

14. Apparatus according to claim 5 wherein said one latch element is elongate and is rotatable about its longitudinal axis into and out of said engagement.

15. Apparatus according to claim 3 wherein said one latch element is movable against said bias by hand from outside the housing.

16. Apparatus according to claim 4 wherein said one latch element is movable against said bias by hand from outside the housing.

17. A cabinet drawer comprising a cabinet housing and a drawer forming a slidable body mounted to be slidable in and out of the housing, and apparatus for holding the slidable body at a selected position intermediate fully retracted and fully extended positions with respect to a housing for the body, wherein the apparatus comprises:
a first latch element mounted to the housing adjacent the path traversed by the slidable body; and
a second latch element on the slidable body;
wherein one of the latch elements is mounted for movement into and out of engagement with the other latch element to hold the slidable body at an intermediate position defined by the other latch element;
and wherein said one latch element is biased either into or out of said engagement, and is movable against the bias from outside the housing.

18. A cabinet drawer according to claim 17 wherein said one latch element is movable against said bias by hand from outside the housing.

19. A cabinet drawer according to claim 17 wherein said one latch element is pivotable into and out of said engagement.

20. A cabinet drawer according to claim 17 wherein said one latch element is elongate and is rotatable about its longitudinal axis into and out of said engagement.
